(19) United States
(12) Patent Application Publication
(10) Pub. No.: US 2012/0203551 A1
(43) Pub. Date: Aug. 9, 2012

(54) AUTOMATED FOLLOW UP FOR E-MEETINGS

(75) Inventors: Geetika T. Lakshmanan, Winchester, MA (US); Martin Oberhofer, Bondorf (DE)

(73) Assignee: International Business Machines Corporation, Armonk, NY (US)

(21) Appl. No.: 13/021,470

(22) Filed: Feb. 4, 2011

(51) Int. Cl. G10L 15/26; G06Q 10/00

(52) U.S. Cl. 704/235; 705/1.1; 704/E15.043

(57) ABSTRACT

Embodiments of the present invention provide a method, system and computer program product for automated follow-up for e-meetings. In an embodiment of the invention, a method for automated follow-up for e-meetings is provided. The method includes monitoring content provided to an e-meeting managed by an e-meeting server executing in memory of a host computer. The method also includes applying a rule in a rules base to the monitored content. Finally, the method includes triggering generation of a follow up item in response to applying the rule to the monitored content.

### BACKGROUND OF THE INVENTION

1. Field of the Invention

The present invention relates to the filed of e-meeting management and more particularly to processing follow-up to an e-meeting.

2. Description of the Related Art

An electronic meeting, hereinafter “e-meeting”, in its broadest sense, is a collaboration between individuals that occurs electronically over a computer communications network. In a typical e-meeting, different individuals exchange messages through a computer interface to a common location. The most rudimentary form of an e-meeting is a discussion forum in which postings in a thread pertaining to a particular topic are provided serially in an asynchronous conversation. More advanced forms of an e-meeting provide for real-time exchanges of messages such as is the case in a chat room. E-meeting platforms combine multiple different collaborative technologies to emulate a “real”, “live”, “in-person” conference. Those technologies include audio and video conferencing over the Internet, instant messaging and chat room, polling, white boarding, and application sharing. Of note, the leading edge of e-meetings has found common ground with the virtual world platform in which participants to an e-meeting can be represented visually to other participants by way of an avatar and the venue for the e-meeting can be a simulated virtual environment.

E-meetings can range from just a few participants to hundreds if not thousands of participants. In the former circumstance, it is expected that all invited participants attend. In the latter circumstance, it is expected that a large number of invited participants will not attend. In either circumstance, but especially for the larger e-meetings, to accommodate those invited participants unable to attend an e-meeting, the entirety of the e-meeting can be “recorded” for later playback. Akin to a chat transcript, a recorded e-meeting is nothing more than the persistence of the different frames of the e-meeting broadcast to the participants in real time during the conduct of the e-meeting. Those frames include not just chat transcripts from ongoing chats during the e-meeting, but also images of screen sharing, white boarding and the like. Optionally, both audio and video data can be recorded for playback along with the frames.

During the course of an e-meeting, just as in the case of a traditional live meeting, moments can occur calling for an action to occur in the future, or at least meriting note taking. Such items are known in business parlance as “follow ups” or “takeaways”. Generally, participants in a live meeting will take notes during a meeting and use those notes to recall important events or concepts that were conveyed during the meeting, or to establish tasks or events in a calendar for the future. A similar approach can be taken in the context of an e-meeting where participants to the e-meeting can engage in manual note taking in order to prompt the later scheduling of a task or event, or to record information of particular importance. However, for invitees to the e-meeting unable to attend, or even for invitees attending an e-meeting but not privy to the note taking of other participants, the knowledge embodied by the follow-up data will have been lost.

### BRIEF SUMMARY OF THE INVENTION

Embodiments of the present invention address deficiencies of the art in respect to follow-up management for e-meetings and provide a novel and non-obvious method, system and computer program product for automated follow-up for e-meetings. In an embodiment of the invention, a method for automated follow-up for e-meetings is provided. The method includes monitoring content provided to an e-meeting managed by an e-meeting server executing in memory of a host computer. The method also includes applying a rule in a rules base to the monitored content. Finally, the method includes triggering generation of a follow up item in response to applying the rule to the monitored content.

In another embodiment of the invention, an e-meeting data processing system can be configured for automated follow-up for e-meetings. The system can include an e-meeting server executing in memory of a host computer and managing an e-meeting attended by different e-meeting participants. The system further can include a rules base of rules. Each of the rules can direct the generation of a follow up item in response to at least one term present in supplied content for the e-meeting. Finally, the system can include an automated follow up module coupled to the e-meeting server and the rules base. The module can include program code enabled to monitor content provided in the e-meeting, to apply a rule in the rules base to the monitored content, and to trigger generation of a follow up item in response to applying the rule to the monitored content.

In one aspect of the embodiment, the follow up item is an event to be scheduled in a calendaring and scheduling system separate from the e-meeting server. In another aspect of the embodiment, the follow up item is a task to be scheduled in a calendaring and scheduling system separate from the e-meeting server. In yet another aspect of the embodiment, the follow up item is a new e-meeting to be scheduled in the e-meeting server. Finally, in even yet another aspect of the embodiment, the follow up item is a note incorporating at least one term present in the monitored content.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated follow-up for e-meetings;

FIG. 2 is a schematic illustration of an e-meeting data processing system configured for automated follow-up for e-meetings; and,

FIG. 3 is a flow chart illustrating a process for automated follow-up for e-meetings.

### DETAILED DESCRIPTION OF THE INVENTION

Embodiments of the invention provide for automated follow-up for e-meetings. In accordance with an embodiment of the invention, content in an e-meeting such as that occurring by way of a Web conference or virtual conference in a virtual world, can be monitored. Textual terms and phrases arising during the e-meeting can be mapped to a rules base and select ones of the terms and phrases, either alone or in particular sequence, when detected can trigger an annotation to the e-meeting such as the creation of a separate note, the persistence of a particular image from the e-meeting like a white board screen shot or application sharing screen shot, the creation of a future event or task in a calendar, the generation of a message to be transmitted to one or more individuals, or the creation of a future e-meeting, to name only a few possible annotations. The annotations, once created, can be linked to a persisted form of the e-meeting for later access.

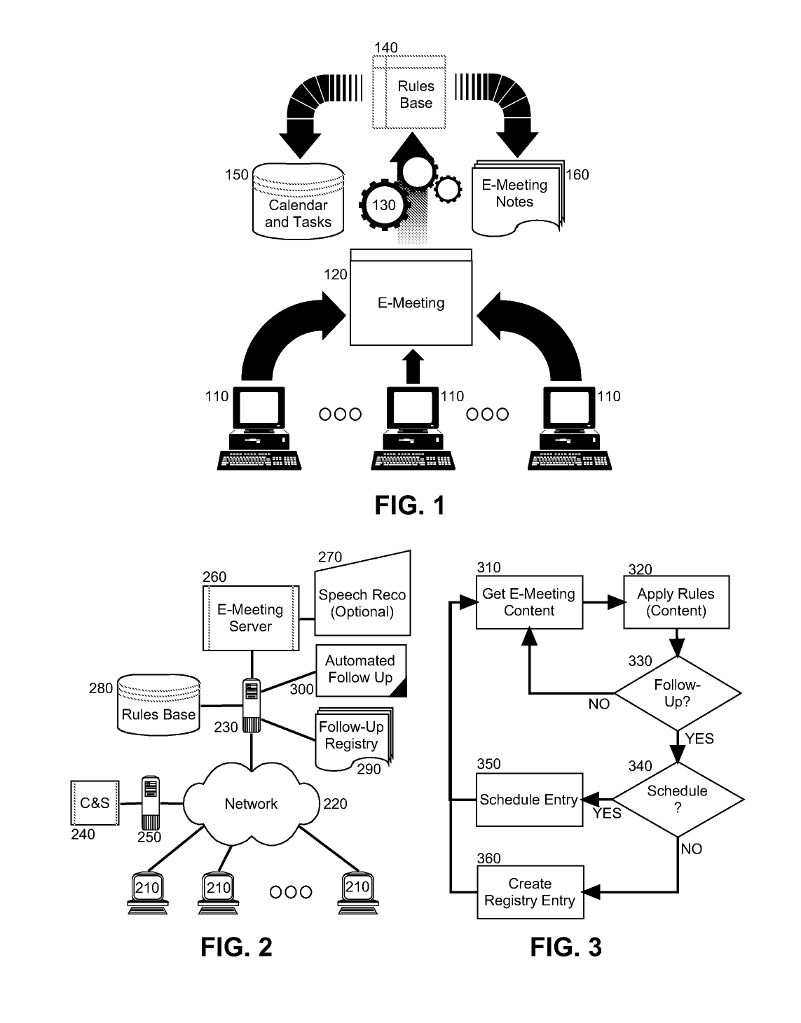

In further illustration, FIG. 1 pictorially shows a process for automated follow-up for e-meetings. As shown in FIG. 1, different end users 110 can participate in an e-meeting 120 through respective computers. Participation in the e-meeting 120 by the end users 110 can include exchanges of instant messages in a chat session, providing audio input in an audio conference portion of the e-meeting 120, or video input in a video conference portion of the e-meeting, sharing a document through application sharing, engaging in white boarding and the like. Consequently, content can be provided by the end users 110 through the e-meeting 120. Automated follow-up logic 130 can monitor the content provided by the end users 110 in the e-meeting 120 and can apply rules in a rules base 140 to the content.

In this regard, the rules of the rules base 140 can specify when the detection of a term or series of terms in the content is to trigger a follow up item. For instance, upon detecting a sequence of terms within a threshold period of time, a to-do also known as a task can be automatically generated and placed into a repository of events and tasks 150 for one or more of the end users 110. As another example, in response to detecting a set of terms in the content, an event can be scheduled in the repository of events and tasks 150 for the end users 110 using a date and time determined from the detected set of terms. As even yet another example, in response to detecting one or more terms in the content, a note can be generated and stored amongst a set of e-meeting notes 160 accessible to the end users 110 with the detected set of terms. In this way, follow up items for the e-meeting 120 can be persisted for the benefit of all end users 110, even if one or more of the end users 110 is not able to attend the e-meeting 120 or to grant full attention to the e-meeting 120.

The process described in connection with FIG. 1 can be implemented in an e-meeting data processing system. In further illustration, FIG. 2 schematically shows an e-meeting data processing system configured for automated follow-up for e-meetings. The system can include a host server 230 with at least one processor and memory configured for communicative coupling to different end user computing devices 210 over a computer communications network 220. The host server 230 can support the execution in memory of an e-meeting server 260, for example a Web conferencing system or a virtual world platform. Optionally, a speech recognition system 270 can be included with the e-meeting server 260 to produce text from audio speech provided to the e-meeting server 260 as part of an audio conference.

An automated follow up module 300 can be coupled to the e-meeting server 260. The automated follow up module 300 can include program code that when executed in memory of the host server 230 can monitor content provided in an e-meeting managed by the e-meeting server 260. The program code when executed further can apply one or more rules in a rules base 280 to the monitored content to determine whether or not to trigger a follow up action, such as generating a note in a follow up registry 290, or scheduling a meeting, event or task in a calendaring and scheduling system 240 executing in memory of a host computer 250 coupled to the e-meeting server 260. Optionally, speech recognized content produced by speech recognition engine 270 can be monitored and the speech recognized content also can be subjected to the rules of the rules base 280.

Of note the rules of the rules base 280 can provide simple triggers for triggering follow items, such as, “In response to detecting the term ABC, generate a note in the follow up registry 290 that states XYZ.” Another more complex rule can include, “In response to detecting the term ABC in a white boarding session of the e-meeting, and detecting within five minutes the term DEF in a chat session of the e-meeting, generate a note in the follow up registry 290 that states ABC DEF”. Yet another rule can include, “In response to detecting the term ABC within ten terms of the term DEF, schedule an event for a date and time DEF”. Even yet another rule can include, “In response to detecting the term ABC within five minutes of detecting the term DEF, schedule a follow up e-meeting for a date and time DEF”.

In more particular illustration of the operation of the logic of the automated follow up module 300, FIG. 3 is a flow chart illustrating a process for automated follow-up for e-meetings. Beginning in bloc 310, e-meeting content 310 can be detected. In this regard, textual content in one or more applications of the e-meeting, such as a chat application, white boarding session, applications sharing session, or presentation session can be parsed on a term by term basis. In block 320, one or more rules of a rules base can be applied to one or more of the parsed terms. In decision block 330, based upon an application of the rules of the rules base, it can be determined whether or not a follow up item is to be generated in response to the application of the rules to the terms. If so, in decision block 340, it can further be determined on the basis of one or more of the rules of the rules base whether or not to schedule as the follow up item a new e-meeting, a different event or a task. If so, in block 350, a new e-meeting, different event or task can be scheduled in a coupled calendaring and scheduling system as the case may be. Otherwise, in block 360 a note can be generated for placement in a follow up registry as directed by the rules of the rules base. Thereafter, the follow up registry can be accessed by different end users seeking to access the notes generated according to the rules of the rules base applied to the content of a corresponding e-meeting.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated follow-up for e-meetings, the method comprising:
monitoring content provided to an e-meeting managed by an e-meeting server executing in memory of a host computer;
applying a rule in a rules base to the monitored content; and,
triggering generation of a follow up item in response to applying the rule to the monitored content.

2. The method of claim 1, wherein monitoring content provided to an e-meeting comprises speech recognizing audio provided to the e-meeting into textual content and monitoring the textual content speech recognized from the audio.

3. The method of claim 1, wherein the rule directs the generation of the follow up item when a pre-specified term is present in the monitored content.

4. The method of claim 1, wherein the rule directs the generation of the follow up item when a set of pre-specified terms is present in the monitored content.

5. The method of claim 1, wherein triggering generation of a follow up item in response to applying the rule to the monitored content comprises triggering scheduling of an event in a calendaring and scheduling system separate from the e-meeting server in response to applying the rule to the monitored content.

6. The method of claim 1, wherein triggering generation of a follow up item in response to applying the rule to the monitored content comprises triggering scheduling of a task in a calendaring and scheduling system separate from the e-meeting server in response to applying the rule to the monitored content.

7. The method of claim 1, wherein triggering generation of a follow up item in response to applying the rule to the monitored content comprises triggering scheduling of a different e-meeting in the e-meeting server in response to applying the rule to the monitored content.

8. The method of claim 1, wherein triggering generation of a follow up item in response to applying the rule to the monitored content comprises triggering generation of a note in a follow up registry, the note comprising at least a portion of the monitored content.

9. An e-meeting data processing system configured for automated follow-up for e-meetings, the system comprising:
an e-meeting server executing in memory of a host computer and managing an e-meeting attended by a plurality of e-meeting participants;
a rules base of rules, each of the rules directing generation of a follow up item in response to at least one term present in supplied content for the e-meeting; and,
an automated follow up module coupled to the e-meeting server and the rules base, the module comprising program code enabled to monitor content provided in the e-meeting, to apply a rule in the rules base to the monitored content, and to trigger generation of a follow up item in response to applying the rule to the monitored content.

10. The system of claim 9, wherein the follow up item is an event to be scheduled in a calendaring and scheduling system separate from the e-meeting server.

11. The system of claim 9, wherein the follow up item is a task to be scheduled in a calendaring and scheduling system separate from the e-meeting server.

12. The system of claim 9, wherein the follow up item is a new e-meeting to be scheduled in the e-meeting server.

13. The system of claim 9, wherein the follow up item is a note incorporating at least one term present in the monitored content.

14. A computer program product for automated follow-up for e-meetings, the computer program product comprising:
a computer readable storage medium having computer readable program code embodied therewith, the computer readable program code comprising:
computer readable program code for monitoring content provided to an e-meeting managed by an e-meeting server executing in memory of a host computer;
computer readable program code for applying a rule in a rules base to the monitored content; and,
computer readable program code for triggering generation of a follow up item in response to applying the rule to the monitored content.

15. The computer program product of claim 14, wherein the computer readable program code for monitoring content provided to an e-meeting comprises computer readable program code for speech recognizing audio provided to the e-meeting into textual content and monitoring the textual content speech recognized from the audio.

16. The computer program product of claim 14, wherein the rule directs the generation of the follow up item when a pre-specified term is present in the monitored content.

17. The computer program product of claim 14, wherein the rule directs the generation of the follow up item when a set of pre-specified terms is present in the monitored content.

18. The computer program product of claim 14, wherein the computer readable program code for triggering generation of a follow up item in response to applying the rule to the monitored content comprises computer readable program code for triggering scheduling of an event in a calendaring and scheduling system separate from the e-meeting server in response to applying the rule to the monitored content.

19. The computer program product of claim 14, wherein the computer readable program code for triggering generation of a follow up item in response to applying the rule to the monitored content comprises computer readable program code for triggering scheduling of a task in a calendaring and scheduling system separate from the e-meeting server in response to applying the rule to the monitored content.

20. The computer program product of claim 14, wherein the computer readable program code for triggering generation of a follow up item in response to applying the rule to the monitored content comprises computer readable program code for triggering scheduling of a different e-meeting in the e-meeting server in response to applying the rule to the monitored content.

21. The computer program product of claim 14, wherein the computer readable program code for triggering generation of a follow up item in response to applying the rule to the monitored content comprises computer readable program code for triggering generation of a note in a follow up registry, the note comprising at least a portion of the monitored content.
